(19) United States
(12) Patent Application Publication
(10) Pub. No.: US 2025/0266616 A1
(43) Pub. Date: Aug. 21, 2025

(54) ANTENNA ASSEMBLY AND ELECTRONIC DEVICE

(71) Applicant: GUANGDONG OPPO MOBILE TELECOMMUNICATIONS CORP., LTD., Dongguan (CN)

(72) Inventor: Shengjie YANG, Dongguan (CN)

(21) Appl. No.: 19/189,658

(22) Filed: Apr. 25, 2025

Related U.S. Application Data
(63) Continuation of application No. PCT/CN2023/124180, filed on Oct. 12, 2023.

(30) Foreign Application Priority Data
Dec. 29, 2022 (CN) 202211710706.8

(51) Int. Cl. H01Q 5/371; H01Q 1/24; H01Q 5/50

(52) U.S. Cl. CPC H01Q 5/371; H01Q 1/243; H01Q 5/50

(57) ABSTRACT

Provided are an antenna assembly and an electronic device including the same. The antenna assembly includes a first radiation branch and a second radiation branch at an angle relative to each other, and a feeding excitation branch located between the first and second radiation branches. The feeding excitation branch includes a feeding point configured to receive a feeding signal. The feeding excitation branch is electrically coupled with the first radiation branch to couple the feeding signal to the first radiation branch and provide a first coupled feeding signal, and it is further magnetically coupled with the second radiation branch to couple the feeding signal to the second radiation branch and provide a second coupled feeding signal. The phase difference between the first and second coupled feeding signals is 90°, so that the first and second radiation branches have circular polarization or elliptical polarization radiation characteristics, for supporting satellite communication.

### CROSS-REFERENCE OF RELATED APPLICATION

This application is a continuation of International Application No. PCT/CN 2023/124180 filed Oct. 12, 2023, which claims priority to Chinese patent application No. 202211710706.8 filed Dec. 29, 2022. The entire contents of them are hereby incorporated by reference for all purposes.

### TECHNICAL FIELD

The present disclosure relates to the field of communication technologies, and in particular to an antenna assembly and an electronic device having the antenna assembly.

### BACKGROUND

At present, with the popularization of 5G communication technology, people's communication experience is getting better and better. In order to meet different communication needs, some electronic devices are equipped with satellite antennas which establish connections with satellites to achieve satellite communication. The structure of the existing satellite antenna is relatively complex. In addition, in order to improve the quality of satellite communication, the size of the existing satellite antenna is large, which leads to a large size of the electronic device equipped with such satellite antenna, resulting in inconvenience in carrying such electronic device.

### SUMMARY

In a first aspect, an antenna assembly is provided. The antenna assembly includes a first radiation branch, a second radiation branch, and a feeding excitation branch. The first radiation branch and the second radiation branch are at an angle relative to each other. The feeding excitation branch is located between the first radiation branch and the second radiation branch. The feeding excitation branch includes a feeding point configured to receive a feeding signal. The feeding excitation branch is configured to be electrically coupled with the first radiation branch, to couple the feeding signal to the first radiation branch and provide a first coupled feeding signal fed into the first radiation branch. The feeding excitation branch is further configured to be magnetically coupled with the second radiation branch, to couple the feeding signal to the second radiation branch and provide a second coupled feeding signal fed into the second radiation branch. A phase difference between the first coupled feeding signal and the second coupled feeding signal is 90°, so that the first radiation branch and the second radiation branch have circular polarization radiation characteristics or elliptical polarization radiation characteristics, and the antenna assembly is enabled to support reception and/or transmission of a satellite communication signal.

In a second aspect, an electronic device is further provided. The electronic device includes an antenna assembly. The antenna assembly includes a first radiation branch, a second radiation branch, and a feeding excitation branch. The first radiation branch and the second radiation branch are at an angle relative to each other. The feeding excitation branch is located between the first radiation branch and the second radiation branch. The feeding excitation branch includes a feeding point configured to receive a feeding signal. The feeding excitation branch is configured to be electrically coupled with the first radiation branch, to couple the feeding signal to the first radiation branch and provide a first coupled feeding signal fed into the first radiation branch. The feeding excitation branch is further configured to be magnetically coupled with the second radiation branch, to couple the feeding signal to the second radiation branch and provide a second coupled feeding signal fed into the second radiation branch. A phase difference between the first coupled feeding signal and the second coupled feeding signal is 90°, so that the first radiation branch and the second radiation branch have circular polarization radiation characteristics or elliptical polarization radiation characteristics, and the antenna assembly is enabled to support reception and/or transmission of a satellite communication signal.

### BRIEF DESCRIPTION OF THE DRAWINGS

In order to more clearly illustrate technical solutions in the embodiments of the present disclosure, the drawings required for use in the embodiments of the present disclosure will be described below.

FIG. 1 is a simple structural schematic diagram of an antenna assembly in some embodiments of the present disclosure.

FIG. 2 is another simple structural schematic diagram of the antenna assembly in some embodiments of the present disclosure.

FIG. 3 is a schematic diagram illustrating current distribution of the antenna assembly under electrical coupling and magnetic coupling in some embodiments of the present disclosure.

FIG. 4 is a further structural schematic diagram of the antenna assembly in some embodiments of the present disclosure.

FIG. 5 is yet a further structural schematic diagram of the antenna assembly in some embodiments of the present disclosure.

FIG. 6 is a schematic diagram illustrating an internal structure of a tuner in some embodiments of the present disclosure.

FIG. 7 is a structural block diagram of an electronic device in some embodiments of the present disclosure.

FIG. 8 is a schematic plan view of an electronic device in some embodiments of the present disclosure.

FIG. 9 is a partial structural schematic diagram of an electronic device including the aforementioned antenna assembly in some embodiments of the present disclosure.

FIG. 10 is a schematic diagram of a first three-dimensional axial ratio simulation of the electronic device in some embodiments of the present disclosure.

FIG. 11 is a schematic diagram of a second three-dimensional axial ratio simulation of the electronic device in some embodiments of the present disclosure.

FIG. 12 is another schematic plan view of the electronic device in some embodiments of the present disclosure.

FIG. 13 is a further structural block diagram of the electronic device in some embodiments of the present disclosure.

### DETAILED DESCRIPTION OF PREFERRED EMBODIMENTS

The technical solutions in the embodiments of the present disclosure will be described clearly and comprehensively below in conjunction with the drawings in the embodiments of the present disclosure. Apparently, the described embodiments are only part of the embodiments of the present disclosure, rather than all the embodiments. All other embodiments, obtained by those of ordinary skill in the art based on the embodiments of the present disclosure without paying creative work, fall within the scope of protection of the present disclosure.

It is notable that, in the description of the embodiments of the present disclosure, the orientational or positional relationship indicated by terms such as “upper”, “lower”, “thickness”, and “width” is based on the orientational or positional relationship shown in the accompanying drawings, and is only for the convenience of describing the present disclosure and simplifying the description, rather than implying or indicating that the device or element referred to must have a specific orientation, or be constructed and operated in a specific orientation, and therefore they cannot be understood as a limitation on the present disclosure. The term “connect” in the disclosure mainly refers to a physical structural connection, unless otherwise specified; and if particularly specified, it may also include electrical connection, direct connection or indirect connection. In the description of the embodiments of the present disclosure, terms “first”, “second”, etc. are not specific but are used to distinguish objects with the same name. If particularly specified in the specification, the objects with the same name referred to by the terms “first”, “second”, etc. may be the same object.

Embodiments of the present disclosure provide an antenna assembly and an electronic device, by which the satellite communication function is enabled through a simple antenna structure without increasing the size of the electronic device. The provided antenna assembly and electronic device are described in detail below.

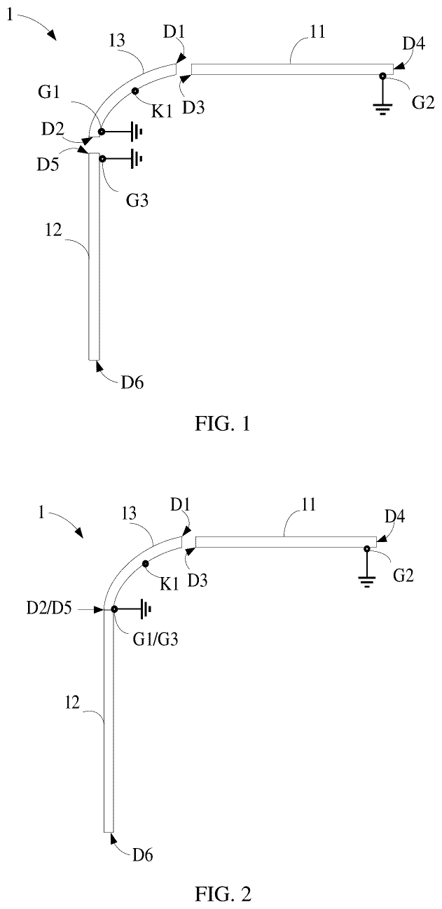

Referring to FIG. 1, a simple structural schematic diagram of an antenna assembly 1 in some embodiments of the present disclosure is shown. As illustrated in FIG. 1, the antenna assembly 1 includes a first radiation branch 11, a second radiation branch 12 and a feeding excitation branch 13. The first radiation branch 11 and the second radiation branch 12 are at an angle relative to each other. The feeding excitation branch 13 is located between the first radiation branch 11 and the second radiation branch 12, and is spaced apart from each of the first radiation branch 11 and the second radiation branch 12. The feeding excitation branch 13 includes a feeding point K 1 configured to receive a feeding signal. The feeding excitation branch 13 is electrically coupled with the first radiation branch 11, to couple the feeding signal to the first radiation branch 11 and thus provide a first coupled feeding signal fed into the first radiation branch 11. The feeding excitation branch 13 is further magnetically coupled with the second radiation branch 12, to couple the feeding signal to the second radiation branch 12 and thus provide a second coupled feeding signal fed into the second radiation branch 12. A phase difference between the first coupled feeding signal and the second coupled feeding signal is 90°, so that the first radiation branch 11 and the second radiation branch 12 have circular polarization radiation characteristics or elliptical polarization radiation characteristics, and the antenna assembly 1 is enabled to support reception and/or transmission of satellite communication signals.

That is, in the present disclosure, the feeding excitation branch 13 is electrically coupled with the first radiation branch 11 and also magnetically coupled with the second radiation branch 12, so that the phase difference between the two coupled feeding signals obtained respectively through the electrical coupling and the magnetic coupling of the feeding signal received by the feeding excitation branch 13 is 90°. In addition, the first radiation branch 11 and the second radiation branch 12 is at an angle relative to each other. As such, the first radiation branch 11 and the second radiation branch 12 have circular polarization radiation characteristics or elliptical polarization radiation characteristics. Accordingly, the reception and/or transmission of satellite communication signals is enabled through a simple and compact structure.

In the present disclosure, the feeding excitation branch 13 serves as a feeding excitation structure, which is used to couple the received feeding signal to the first radiation branch 11 through electrical coupling and couple the received feeding signal to the second radiation branch 12 through magnetic coupling, and plays a role in transferring the feeding signal for excitation. The feeding excitation branch itself may not participate in radiation.

In some embodiments, the feeding excitation branch 13 further includes a first end D1, a second end D2 and a first ground point G1. The first ground point G1 is configured for grounding, and provided at the second end D2. The first end D1 is an open-circuit end. The feeding point K1 is provided at a position between the first ground point G1 and the first end D1. The first radiation branch 11 includes a third end D3, a fourth end D4 and a second ground point G2. The second ground point G2 is configured for grounding, and provided at the fourth end D4. The third end D3 is an open-circuit end. The second radiation branch 12 includes a fifth end D5, a sixth end D6 and a third ground point G3. The third ground point G3 is configured for grounding, and provided at the fifth end D5. The sixth end D6 is an open-circuit end. The first end D1 of the feeding excitation branch 13 is directly opposite to and spaced apart from the third end D3 of the first radiation branch 11. The second end D2 of the feeding excitation branch 13 is directly opposite to and spaced apart from the fifth end D5 of the second radiation branch 12, or the second end D2 of the feeding excitation branch 13 is connected to the fifth end D5 of the second radiation branch 12 and the first ground point G1 coincides with the third ground point G3.

In this case, the first end D1 of the feeding excitation branch 13 is an open-circuit end, and the second end D2 of the feeding excitation branch 13 is a grounding end grounded through the first ground point G1. The third end D3 of the first radiation branch 11 is also an open-circuit end, and the fourth end D4 of the first radiation branch 11 is a grounding end grounded through the second ground point G2. The fifth end D5 of the second radiation branch 12 is a grounding end grounded through the third ground point G3, and the sixth end D6 of the second radiation branch 12 is also an open-circuit end. The electric field at the first end D1 of the feeding excitation branch 13 serving as the open-circuit end is the largest, and since the first end D1 of the feeding excitation branch 13 serving as an open-circuit end is directly opposite to and spaced apart from the third end D3 of the first radiation branch 11 serving as an open-circuit end, the strongest electric field coupling can be thereby generated, and the electrical coupling between the feeding excitation branch 13 and the first radiation branch 11 is provided. In addition, the current at the second end D2 of the feeding excitation branch 13 serving as the grounding end is the largest, and the magnetic field intensity is proportional to the current. Therefore, the magnetic field intensity at the second end D2 of the feeding excitation branch 13 serving as the grounding end is the largest. And since the second end D2 of the feeding excitation branch 13 serving as the grounding end is directly opposite to and spaced apart from the fifth end D5 of the second radiation branch 12 serving as the grounding end, or the second end D2 of the feeding excitation branch 13 is connected to the fifth end D5 of the second radiation branch 12 and the first ground point G1 coincides with the third ground point G3, the strongest magnetic field coupling can be thereby generated, and the magnetic coupling between the feeding excitation branch 13 and the second radiation branch 12 is provided.

In the present disclosure, the electrical coupling refers to electric field coupling, and the magnetic coupling refers to magnetic field coupling. Due to the characteristics of electromagnetic wave signals, the electric field and the magnetic field are perpendicular to each other, so that the phase difference between the two coupled feeding signals obtained respectively through the electrical coupling and the magnetic coupling of the feeding signal received by the feeding excitation branch 13 is 90°.

As illustrated in FIG. 1, the second end D2 of the feeding excitation branch 13 serving as the grounding end is directly opposite to and spaced apart from the fifth end D5 of the second radiation branch 12 serving as the grounding end.

Referring to FIG. 2, another simple structural schematic diagram of the antenna assembly 1 in some embodiments of the present disclosure is shown. As illustrated in FIG. 2, different from those shown in FIG. 1, the second end D2 of the feeding excitation branch 13 serving as the grounding end is directly connected to the fifth end D5 of the second radiation branch 12 serving as the grounding end, and the first ground point G1 coincides with the third ground point G3.

In the case illustrated in FIG. 2, since the sixth end D6 of the second radiation branch 12 is an open-circuit end, and the current at the second end D2 of the feeding excitation branch 13 serving as the grounding end and the fifth end D5 of the second radiation branch 12 serving as the grounding end is the largest, the magnetic coupling between the feeding excitation branch 13 and the second radiation branch 12 is also provided, and the second coupled feeding signal is generated in the second radiation branch 12 through excitation, thereby feeding the second coupled feeding signal into the second radiation branch 12.

Therefore, in some embodiments, the second end D2 of the feeding excitation branch 13 serving as the grounding end may be directly connected to the fifth end D5 of the second radiation branch 12 serving as the grounding end, which can also achieve the magnetic coupling while reducing gaps, and the stability of the overall structure of the antenna assembly 1 is improved.

The second ground point G2 being provided at the fourth end D4 does not necessarily mean that the second ground point G2 needs to be exactly provided at the fourth end D4, but may also include a situation where the second ground point G2 is provided at a position close to the fourth end D4. In the case where the second end D2 of the feeding excitation branch 13 serving as the grounding end is directly opposite to and spaced apart from the fifth end D5 of the second radiation branch 12 serving as the grounding end, the first ground point G 1 provided at the second end D2 does not need to be exactly provided at the second end D2, and it may also include a situation where the first ground point G1 is provided at a position close to the second end D2; and the third ground point G3 provided at the fifth end D5 does not need to be exactly provided at the fifth end D5, and it may also include a situation where the third ground point G3 is provided at a position close to the fifth end D5.

In some embodiments, the first radiation branch 11 and the second radiation branch 12 being at an angle relative to each other means that there is an angle between the first radiation branch 11 and the second radiation branch 12 greater than 0° and less than 180°.

In some embodiments, when the angle between the first radiation branch 11 and the second radiation branch 12 is 90°, the vertical polarization requirement of a circular polarization antenna is met. In this case, the first radiation branch 11 and the second radiation branch 12 can have relatively exact circular polarization radiation characteristics.

In some embodiments, when the first radiation branch 11 and the second radiation branch 12 are at an angle other than 90°, the first radiation branch 11 and the second radiation branch 12 are not completely vertically polarized, but have elliptical polarization radiation characteristics. In this case, the antenna radiation performance would be lower than the antenna radiation performance under the circular polarization radiation characteristics, but it can still meet the requirements for satellite communication.

In some embodiments, in order to obtain better circular polarization or elliptical polarization radiation performance of the first radiation branch 11 and the second radiation branch 12, the angle between the first radiation branch 11 and the second radiation branch 12 may be greater than 10° and less than 170°.

In some embodiments, as illustrated in FIG. 1, the angle between the first radiation branch 11 and the second radiation branch 12 is 90°, so that the first radiation branch 11 and the second radiation branch 12 are orthogonal to each other. And when the phase difference between the two coupled feeding signals respectively fed into the first radiation branch 11 and the second radiation branch 12 is 90°, vertical orthogonal polarization in a strict sense can be achieved. As mentioned above, the exact circular polarization radiation performance can be achieved, and the maximum radiation performance for satellite communication is enabled.

Evidently, when the angle between the first radiation branch 11 and the second radiation branch 12 is not 90°, that is, when the angle is other values greater than 0° and less than 180°, the circular polarization radiation performance would be decreased, and elliptical polarization radiation characteristics would be provided, but it can still meet the requirements for satellite communication and support the satellite communication.

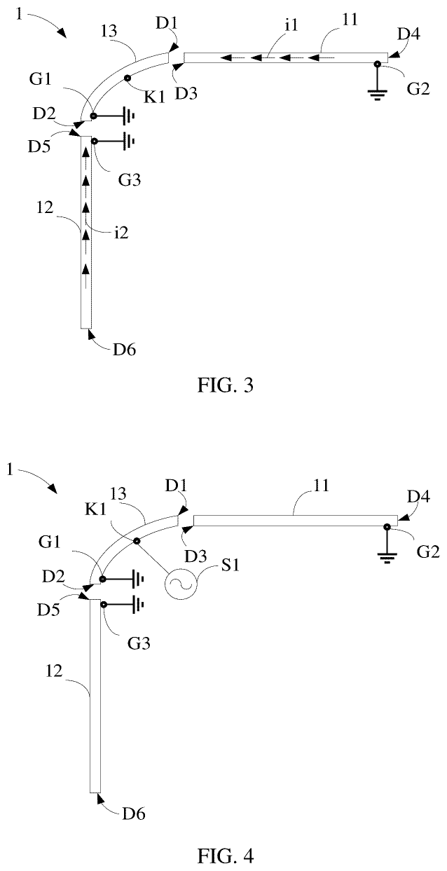

Also referring to FIG. 3, a schematic diagram illustrating current distribution of the antenna assembly 1 under the electrical coupling and magnetic coupling in an embodiment of the present disclosure is shown. FIG. 3 is a schematic diagram illustrating the simulated current distribution obtained when the angle between the first radiation branch 11 and the second radiation branch 12 is 90°, for example, it may be a schematic diagram illustrating the simulated current distribution obtained based on the structure shown in FIG. 1.

As mentioned above, the first end D1 of the feeding excitation branch 13 serving as the open-circuit end is directly opposite to and spaced apart from the third end D3 of the first radiation branch 11 serving as the open-circuit end, and the strongest electric field coupling is thereby generated. As illustrated in FIG. 3, under the effect of the electric field coupling, a current i1 is generated in the first radiation branch 11 and flows along the length direction of the first radiation branch 11. Since the feeding signal itself is a high-frequency current signal, the current i1 is generated in the first radiation branch 11 may be actually regarded as the first coupled feeding signal fed into the first radiation branch 11.

As mentioned above, when the second end D2 of the feeding excitation branch 13 serving as the grounding end is directly opposite to and spaced apart from the fifth end D5 of the second radiation branch 12 serving as the grounding end, or when the second end D2 of the feeding excitation branch 13 is connected to the fifth end D5 of the second radiation branch 12 and the first ground point G1 coincides with the third ground point G3, the strongest magnetic field coupling can be thereby generated. As illustrated in FIG. 3, under the effect of the magnetic field coupling, a current i2 is generated in the second radiation branch 12 and flows along the length direction of the second radiation branch 12. Since the feeding signal itself is a high-frequency current signal, the current i2 generated in the second radiation branch 12 may be actually regarded as the second coupled feeding signal fed into the second radiation branch 12.

As can be seen from FIG. 3, the direction of the current i1 in the first radiation branch 11 is perpendicular to the direction of the current i2 in the second radiation branch 12. As mentioned above, when the phase difference between the two coupled feeding signals, i.e., the currents, fed through the electrical coupling and magnetic coupling respectively into the first radiation branch 11 and the second radiation branch 12 is 90°, vertical orthogonal polarization can be achieved, and the circular polarization radiation characteristics in a strict sense can be achieved, thereby obtaining the optimum radiation performance.

In some embodiments, the feeding signal received at the feeding point K1 may be a feeding signal provided by a feed source or a received satellite communication signal. Specifically, when the antenna assembly 1 is used to transmit a satellite communication signal, the feeding signal received at the feeding point K1 may be a feeding signal provided by a feed source; and when the antenna assembly 1 is used to receive a satellite communication signal, the feeding signal fed into the feeding point K 1 may be a received satellite communication signal.

Also referring to FIG. 4, a further structural schematic diagram of the antenna assembly 1 in some embodiments of the present disclosure is shown. As illustrated in FIG. 4, the antenna assembly 1 further includes a feed source S1 configured to generate the feeding signal. The feeding signal generated by the feed source S1 is coupled to the first radiation branch 11 through the feeding excitation branch 13, to provide the first coupled feeding signal fed into the first radiation branch 11. The feeding signal generated by the feed source S1 is also coupled to the second radiation branch 12 through the feeding excitation branch 13, to provide the second coupled feeding signal fed into the second radiation branch 12. The phase difference between the first coupled feeding signal and the second coupled feeding signal is 90°, so that a satellite communication signal can be transmitted by the first radiation branch 11 under excitation of the first coupled feeding signal and the second radiation branch 12 under excitation of the second coupled feeding signal.

That is, in some embodiments, the antenna assembly 1 supports the transmission of a satellite communication signal(s). After the feeding signal is received from the feed source S1, the feeding signal is coupled to the first radiation branch 11 through the feeding excitation branch 13 to provide the first coupled feeding signal fed into the first radiation branch 11, and the feeding signal generated by the feed source S1 is also coupled to the second radiation branch 12 through the feeding excitation branch 13 to provide the second coupled feeding signal fed into the second radiation branch 12, with the phase difference between the first coupled feeding signal and the second coupled feeding signal being 90°. As such, the first radiation branch 11 and the second radiation branch 12 can transmit the satellite communication signal(s), under excitation of the first coupled feeding signal and the second coupled feeding signal respectively.

In some embodiments, the electrical length of each of the first radiation branch 11 and the second radiation branch 12 is λ₁/4, where λ₁ is a wavelength corresponding to a transmit frequency of the satellite communication signal. λ₁/4 refers to one quarter of λ₁.

When the electrical length of each of the first radiation branch 11 and the second radiation branch 12 is λ₁/4, the first radiation branch 11 and the second radiation branch 12 each resonate at the transmit frequency of the satellite communication signal, to achieve better or optimal radiation performance.

In some embodiments, the electrical length of the feeding excitation branch 13 is also λ₁/4. In a case where the electrical length of the feeding excitation branch 13 is λ₁/4, when the feeding excitation branch 13 receives the feeding signal provided by the feed source S1, the intensity of electric field coupling between the first end D1 serving as the open-circuit end and the third end D3 of the first radiation branch 11 serving as the open-circuit end, which are directly opposite to and spaced apart from each other, can reach its achievable maximum value, and the intensity of magnetic field coupling generated by the second end D2 of the feeding excitation branch 13 serving as the grounding end can also reach its achievable maximum value. For the feeding excitation branch 13 of any electrical length, the intensity of electric field coupling is the strongest at the first end D1 serving as the open-circuit end, and the intensity of magnetic field coupling is the strongest at the second end D2 serving as a short-circuit end. However, when the electrical length of the feeding excitation branch 13 is λ₁/4, λ₁ is the wavelength corresponding to the transmit frequency of the satellite communication signal, at the time of transmitting the satellite communication signal, the intensity of electric field coupling at the first end D1 serving as the open-circuit end would be stronger than the intensity of electric field coupling at this end of the feeding excitation branch 13 with other electrical lengths, and the intensity of magnetic field coupling at the second end D2 serving as the short-circuit end would also be stronger than the intensity of magnetic field coupling at this end of the feeding excitation branch 13 with other electrical lengths; thus, the intensity of electric field coupling and the intensity of magnetic field coupling can all reach the achievable maximum values.

That is, in some embodiments, the electrical lengths of the feeding excitation branch 13, the first radiation branch 11, and the second radiation branch 12 are mainly designed based on the transmission of the satellite communication signal(s).

In some embodiments, the feeding excitation branch 13, the first radiation branch 11 and the second radiation branch 12 are all strip-shaped, and the electrical lengths of the feeding excitation branch 13, the first radiation branch 11 and the second radiation branch 12 may be approximately equal to the lengths of the feeding excitation branch 13, the first radiation branch 11 and the second radiation branch 12 respectively. The first end D1 and the second end D2 of the feeding excitation branch 13 are respectively two ends of the feeding excitation branch 13 in the extension direction thereof, and the length of the feeding excitation branch 13 is approximately a length from the first end D1 to the second end D2 along the extension direction of the feeding excitation branch 13. The third end D3 and the fourth end D4 of the first radiation branch 11 are respectively two ends of the first radiation branch 11 in the extension direction thereof, and the length of the first radiation branch 11 is approximately a length from the third end D3 to the fourth end D4 along the extension direction of the first radiation branch 11. Similarly, the fifth end D5 and the sixth end D6 of the second radiation branch 12 are respectively two ends of the second radiation branch 12 in the extension direction thereof, and the length of the second radiation branch 12 is approximately a length from the fifth end D5 to the sixth end D6 along the extension direction of the second radiation branch 12.

The extension direction of each of the feeding excitation branch 13, the first radiation branch 11 and the second radiation branch 12 refers to an extension direction of a long side of each of the feeding excitation branch 13, the first radiation branch 11 and the second radiation branch 12.

As illustrated in FIG. 1 to FIG. 4, the feeding excitation branch 13 is an arc-shaped strip, and the first radiation branch 11 and the second radiation branch 12 may be a straight strip.

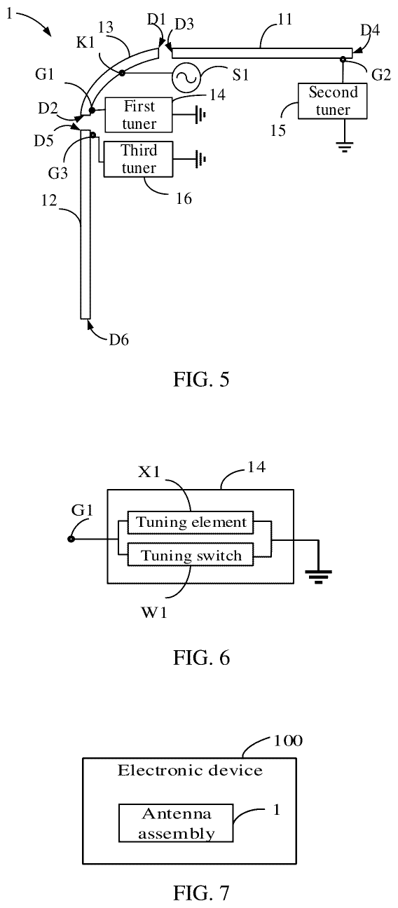

Also referring to FIG. 5, a further structural schematic diagram of the antenna assembly 1 in some embodiments of the present disclosure is shown. The antenna assembly 1 further includes a first tuner 14, a second tuner 15 and a third tuner 16. The first tuner 14 is connected between the first ground point G1 and the ground, the second tuner 15 is connected between the second ground point G2 and the ground, and the third tuner 16 is connected between the third ground point G3 and the ground. That is, in some embodiments, the first ground point G1 is grounded through the first tuner 14, the second ground point G2 is grounded through the second tuner 15, and the third ground point G3 is grounded through the third tuner 16. The first tuner 14, the second tuner 15 and the third tuner 16 are enabled at the time of receiving a satellite communication signal, so as to adjust the electrical lengths of the feeding excitation branch 13, the first radiation branch 11 and the second radiation branch 12 to λ₂/4 for reception of the satellite communication signal, where λ₂ is a wavelength corresponding to the receive frequency of the satellite communication signal. λ_{2/}4 refers to one quarter of λ₂.

That is, in some embodiments, in certain satellite communication systems, the receive frequency and the transmit frequency of the satellite communication signal are different. By configuring the first tuner 14, the second tuner 15 and the third tuner 16 to adjust the electrical lengths, the antenna assembly 1 is further enabled to receive the satellite communication signal.

Therefore, in some embodiments, the antenna assembly 1 can not only receive a satellite communication signal(s), but also transmit a satellite communication signal(s). That is, the antenna assembly 1 can support both the transmission and the reception of the satellite communication signals in a time-sharing manner.

Evidently, in some embodiments, when the receive frequency and the transmit frequency of the satellite communication signal are the same, the first tuner 14, the second tuner 15 and the third tuner 16 may be omitted, and the first ground point G1, the second ground point G2 and the third ground point G3 are directly grounded.

Referring to FIG. 6, a schematic diagram illustrating the internal structure of the tuner in some embodiments of the present disclosure is shown. Each of the first tuner 14, the second tuner 15 and the third tuner 16 includes a tuning element X1 and a tuning switch W1 connected in parallel between a corresponding ground point and the ground. At the time of receiving a satellite communication signal(s), the tuning switch W1 of each of the first tuner 14, the second tuner 15 and the third tuner 16 is turned off, which enables its corresponding tuning element X1, that is, the branch where the corresponding tuning element X1 is located would not be short-circuited by the tuning switch W1 and may be connected between the corresponding ground point and the ground. This enables the first tuner 14, the second tuner 15 and the third tuner 16 at the time of receiving the satellite communication signal(s).

That is, in some embodiments, the enabling of the first tuner 14, the second tuner 15, and the third tuner 16 means that the tuning elements in the first tuner 14, the second tuner 15, and the third tuner 16 are enabled.

In some embodiments, each tuning switch W1 is turned on at the time of transmitting a satellite communication signal(s), and the branch where the corresponding tuning element X1 is located is accordingly short-circuited, so that the branch where the corresponding tuning element X1 is located is disabled. As such, the first ground point G1, the second ground point G2 and the third ground point G3 are directly grounded through the turned-on tuning switches W1. Thus, the first tuner 14, the second tuner 15 and the third tuner 16 are disabled at the time of transmitting the satellite communication signal(s).

In FIG. 6, it is illustrated by taking the first tuner 14 as an example. As illustrated in FIG. 6, the first tuner 14 includes a tuning element X1 and a tuning switch W1 connected in parallel between the first ground point G1 and the ground. Apparently, the second tuner 15 similarly includes a tuning element X1 and a tuning switch W1 connected in parallel between the second ground point G2 and the ground, and the third tuner 16 also includes a tuning element X1 and a tuning switch W1 connected in parallel between the third ground point G3 and the ground.

Each tuning element X1 may include a capacitor and/or an inductor, and when both a capacitor and an inductor are included, the capacitor and the inductor may be connected in parallel or in series. The capacitor and/or inductor of the tuning element X1 included in the first tuner 14 may be equivalent to an electrical length, and the sum of the equivalent electrical length of the tuning element X1 included in the first tuner 14 and the original electrical length of the feeding excitation branch 13 is λ₂/4. Similarly, the capacitor and/or inductor of the tuning element X1 included in the second tuner 15 may be equivalent to an electrical length, and the sum of the equivalent electrical length of the tuning element X1 included in the second tuner 15 and the original electrical length of the first radiation branch 11 is λ₂/4. The capacitor and/or inductor of the tuning element X1 included in the third tuner 16 may be equivalent to an electrical length, and the sum of the equivalent electrical length of the tuning element X1 included in the third tuner 16 and the original electrical length of the second radiation branch 12 is λ₂/4.

Thus, the inductance and/or capacitance of the tuning element X1 included in the first tuner 14 may be preset in such a manner that the sum of the equivalent electrical length of the tuning element X1 and the original electrical length of the feeding excitation branch 13 is λ₂/4. The inductance and/or capacitance of the tuning element X1 included in the second tuner 15 may be preset in such a manner that the sum of the equivalent electrical length of the tuning element X1 and the original electrical length of the first radiation branch 11 is λ₂/4. The inductance and/or capacitance of the tuning element X1 included in the third tuner 16 may be preset in such a manner that the sum of the equivalent electrical length of the tuning element X1 and the original electrical length of the second radiation branch 12 is λ₂/4.

In the case where the electrical length of the feeding excitation branch 13 is adjusted to λ₂/4, when the feeding excitation branch 13 receives a satellite communication signal, the intensity of electric field coupling between the first end D1 serving as the open-circuit end and the third end D3 of the first radiation branch 11 serving as the open-circuit end, which are directly opposite to and spaced apart from each other, reaches its achievable maximum value, and the intensity of magnetic field coupling generated by the second end D2 of the feeding excitation branch 13 serving as the grounding end can also reach its achievable maximum value.

When the electrical lengths of the first radiation branch 11 and the second radiation branch 12 are adjusted to λ₂/4, the first radiation branch 11 and the second radiation branch 12 resonate at the receive frequency of the satellite communication signal, to achieve better or optimal radiation performance.

The first tuner 14 after being enabled is connected to the feeding excitation branch 13, and it may be regarded as a part of the feeding excitation branch 13. The adjusting the electrical length of the feeding excitation branch 13 to λ₂/4 means that the sum of the equivalent electrical length of the tuning element X1 and the original electrical length of the feeding excitation branch 13 is adjusted to λ₂/4; the adjusting the electrical length of the first radiation branch 11 to λ₂/4 means that the sum of the equivalent electrical length of the tuning element X1 and the original electrical length of the first radiation branch 11 is adjusted to λ₂/4; and the adjusting the electrical length of the second radiation branch 12 to λ₂/4 means that the sum of the equivalent electrical length of the tuning element X1 and the original electrical length of the second radiation branch 12 is adjusted to λ₂/4.

In some other embodiments, in the structure shown in FIG. 1, the feeding signal received at the feeding point K1 is a received satellite communication signal, the feeding signal is coupled to the first radiation branch to provide the first coupled feeding signal fed into the first radiation branch, and the feeding signal is also coupled to the second radiation branch to provide the second coupled feeding signal fed into the second radiation branch, with the phase difference between the first coupled feeding signal and the second coupled feeding signal being 90°. As such, the first radiation branch 11 and the second radiation branch 12 can receive the satellite communication signal, under excitation of the first coupled feeding signal and the second coupled feeding signal respectively.

That is, in the some other embodiments, the structure shown in FIG. 1 may also be a structure supporting the reception of satellite communication signals.

In the some other embodiments, the electrical length of each of the first radiation branch 11 and the second radiation branch 12 is λ₂/4, where λ₂ is the wavelength corresponding to the receive frequency of the satellite communication signal. In some other embodiments, the electrical length of the feeding excitation branch 13 is also λ₂/4.

That is, in the some other embodiments, the electrical lengths of the feeding excitation branch 13, the first radiation branch 11 and the second radiation branch 12 are mainly designed based on the reception of the satellite communication signals. For relevant description, reference may be made to the aforementioned related contents that the electrical lengths of the feeding excitation branch 13, the first radiation branch 11 and the second radiation branch 12 are mainly designed based on the transmission of the satellite communication signals.

In the some other embodiments, in the structure shown in FIG. 5, the antenna assembly 1 further includes a first tuner 14, a second tuner 15 and a third tuner 16. The first tuner 14 is connected between the first ground point G1 and the ground, the second tuner 15 is connected between the second ground point G2 and the ground, and the third tuner 16 is connected between the third ground point G3 and the ground. That is, in some embodiments, the first ground point G1 is grounded through the first tuner 14, the second ground point G2 is grounded through the second tuner 15, and the third ground point G3 is grounded through the third tuner 16. The first tuner 14, the second tuner 15 and the third tuner 16 are enabled at the time of transmitting a satellite communication signal, so that the electrical lengths of the feeding excitation branch 13, the first radiation branch 11 and the second radiation branch 12 are adjusted to λ₂/4 to transmit the satellite communication signal, where A1 is the wavelength corresponding to the transmit frequency of the satellite communication signal.

That is, in the some other embodiments, the electrical lengths of the feeding excitation branch 13, the first radiation branch 11 and the second radiation branch 12 are mainly designed based on the reception of the satellite communication signals. By configuring the first tuner 14, the second tuner 15 and the third tuner 16 to be enabled at the time of transmitting a satellite communication signal, the electrical lengths of the feeding excitation branch 13, the first radiation branch 11 and the second radiation branch 12 may be adjusted to λ₂/4 at the time of transmitting the satellite communication signal, so as to realize the transmission of the satellite communication signal.

Similarly, as illustrated in the aforementioned FIG. 6, each of the first tuner 14, the second tuner 15 and the third tuner 16 includes a tuning element X1 and a tuning switch W1 connected in parallel between a corresponding ground point and the ground. At the time of transmitting a satellite communication signal(s), the tuning switch W1 of each of the first tuner 14, the second tuner 15 and the third tuner 16 is turned off, which enables its corresponding tuning element X1, that is, the branch where the corresponding tuning element X1 is located would not be short-circuited by the tuning switch W1 and may be connected between the corresponding ground point and the ground. This enables the first tuner 14, the second tuner 15 and the third tuner 16 at the time of transmitting the satellite communication signal(s).

In the some other embodiments, each tuning switch W1 is turned on at the time of receiving a satellite communication signal(s), and the branch where the corresponding tuning element X1 is located is short-circuited, so that the branch where the corresponding tuning element X1 is located is disabled. As such, the first ground point G1, the second ground point G2 and the third ground point G3 are directly grounded through the turned-on tuning switches W1. Thus, the first tuner 14, the second tuner 15 and the third tuner 16 are disabled at the time of receiving the satellite communication signal(s).

Each tuning element X1 may include a capacitor and/or an inductor, and when both a capacitor and an inductor are included, the capacitor and the inductor may be connected in parallel or in series. The capacitor and/or inductor of the tuning element X1 included in the first tuner 14 may be equivalent to an electrical length, and the sum of the equivalent electrical length of the tuning element X1 included in the first tuner 14 and the original electrical length of the feeding excitation branch 13 is λ₂/4. Similarly, the capacitor and/or inductor of the tuning element X1 included in the second tuner 15 may be equivalent to an electrical length, and the sum of the equivalent electrical length of the tuning element X1 included in the second tuner 15 and the original electrical length of the first radiation branch 11 is λ₂/4. The capacitor and/or inductor of the tuning element X1 included in the third tuner 16 may be equivalent to an electrical length, and the sum of the equivalent electrical length of the tuning element X1 included in the third tuner 16 and the original electrical length of the second radiation branch 12 is λ₂/4.

Thus, in the some other embodiments, the inductance and/or capacitance of the tuning element X1 included in the first tuner 14 may be preset in such a manner that the sum of the equivalent electrical length of the tuning element X1 and the original electrical length of the feeding excitation branch 13 is λ₂/4. The inductance and/or capacitance of the tuning element X1 included in the second tuner 15 may be preset in such a manner that the sum of the equivalent electrical length of the tuning element X1 and the original electrical length of the first radiation branch 11 is λ₂/4. The inductance and/or capacitance of the tuning element X1 included in the third tuner 16 may be preset in such a manner that the sum of the equivalent electrical length of the tuning element X1 and the original electrical length of the second radiation branch 12 is λ₂/4. Thus, in the some other embodiments, the first tuner 14, the second tuner 15 and the third tuner 16 are enabled at the time of transmitting a satellite communication signal(s), so that the antenna assembly 1 can resonate at the transmit frequency of the satellite communication signal(s).

Thus, in the some other embodiments, when the first tuner 14, the second tuner 15 and the third tuner 16 are not enabled, i.e., disabled, the antenna assembly 1 can support the reception of satellite communication signals; and when there is a need to transmit a satellite communication signal, the first tuner 14, the second tuner 15 and the third tuner 16 may be enabled, so that the antenna assembly 1 can support the transmission of the satellite communication signal. Thus, similarly, through the time-sharing manner, both the transmission of satellite communication signals and the reception of satellite communication signals are supported.

As mentioned above, at the time of transmitting the satellite communication signal(s), the feeding signal is provided by the feed source S1.

Referring to FIG. 7, a structural block diagram of an electronic device 100 in some embodiments of the present disclosure is shown. As illustrated in FIG. 7, the electronic device 100 may include the antenna assembly 1 in any of the aforementioned embodiments.

Thus, the electronic device 100 can transmit and/or receive satellite communication signals by being equipped with the antenna assembly 1 having a simple and compact structure as described above, so that the electronic device 100 has a small overall volume of small and is easy to carry.

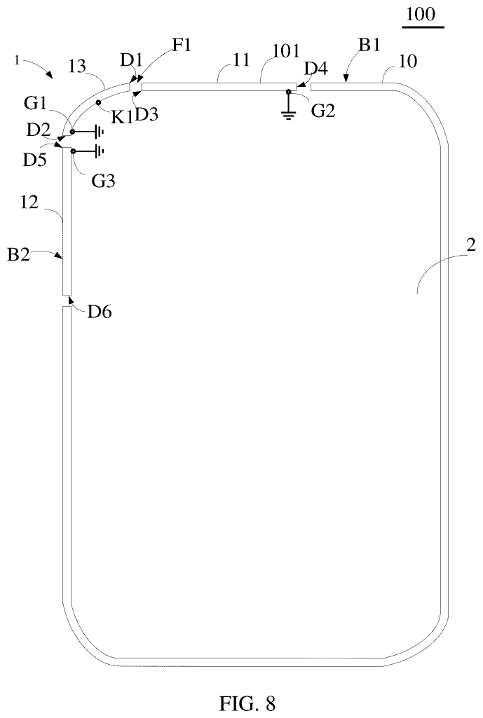

Referring to FIG. 8, a schematic plan view of the electronic device 100 in some embodiments of the present disclosure is shown. As illustrated in FIG. 8, the electronic device 100 further includes a frame 10. The first radiation branch 11, the second radiation branch 12 and the feeding excitation branch 13 are metal segments provided on the frame 10 of the electronic device 100.

As illustrated in FIG. 8, in some embodiments, the frame 10 of the electronic device 100 is a metal frame, and the first radiation branch 11, the second radiation branch 12 and the feeding excitation branch 13 are metal frame segments 101 formed by providing gaps F1 in the metal frame of the electronic device 100. The first radiation branch 11 is formed by a part of the metal frame on a first side B1 of the electronic device 100, and the second radiation branch 12 is formed by a part of the metal frame on a second side B2 of the electronic device 100, the first side B1 and the second side B2 being adjacent to each other. The feeding excitation branch 13 is a metal frame segment at a top corner between the first side B1 and the second side B2.

In the case where the first end D1 of the feeding excitation branch 13 is directly opposite to and spaced apart from the third end D3 of the first radiation branch 11, and the second end D2 of the feeding excitation branch 13 is directly opposite to and spaced apart from the fifth end D5 of the second radiation branch 12, the first radiation branch 11, the second radiation branch 12 and the feeding excitation branch 13 are three independent metal frame segments 101 formed by providing gaps F1 in the metal frame of the electronic device 100. In the case where the first end D1 of the feeding excitation branch 13 is directly opposite to and spaced apart from the third end D3 of the first radiation branch 11, the second end D2 of the feeding excitation branch 13 is connected to the fifth end D5 of the second radiation branch 12 and the first ground point G1 coincides with the third ground point G3, the second radiation branch 12 and the feeding excitation branch 13 are an integral metal frame segment 101, and the first radiation branch 11 is an independent metal frame segment 101 which is spaced, by a gap F1, from the metal frame segment 101 forming the second radiation branch 12 and the feeding excitation branch 13.

In the case where the first end D1 of the feeding excitation branch 13 is directly opposite to and spaced apart from the third end D3 of the first radiation branch 11, the second end D2 of the feeding excitation branch 13 is connected to the fifth end D5 of the second radiation branch 12 and the first ground point G1 coincides with the third ground point G3, the electrical coupling and magnetic coupling can also be achieved, the provided gaps can be reduced, and the stability of the overall structure of the antenna assembly 1 is improved. For the electronic device 100, it can also improve the overall strength of the frame and reduce the complexity of process.

In some embodiments, the frame 10 of the electronic device 100 may also be a non-metal frame, and the first radiation branch 11, the second radiation branch 12 and the feeding excitation branch 13 are metal segments provided at the frame 10 of the electronic device 100.

That is, in some embodiments, the frame 10 of the electronic device 100 may also be a non-metal frame with low conductivity, such as a resin, plastic, or ceramic frame. The first radiation branch 11, the second radiation branch 12 and the feeding excitation branch 13 are metal segments provided at the frame 10 of the electronic device 100.

The first radiation branch 11 is a metal segment provided at a part of the frame 10 on the first side B1 of the electronic device 100, and the second radiation branch 12 is a metal segment provided at a part of the frame 10 on the second side B2 of the electronic device 100, the first side B1 and the second side B2 being adjacent sidestep each other. The feeding excitation branch 13 is a metal segment provided at a part of the frame 10 at the top corner between the first side B1 and the second side B2 of the electronic device 100.

Similarly, in the case where the first end D1 of the feeding excitation branch 13 is directly opposite to and spaced apart from the third end D3 of the first radiation branch 11, and the second end D2 of the feeding excitation branch 13 is directly opposite to and spaced apart from the fifth end D5 of the second radiation branch 12, the first radiation branch 11, the second radiation branch 12 and the feeding excitation branch 13 are three independent metal segments provided at the frame 10 of the electronic device 100. In the case where the first end D1 of the feeding excitation branch 13 is directly opposite to and spaced apart from the third end D3 of the first radiation branch 11, the second end D2 of the feeding excitation branch 13 is connected to the fifth end D5 of the second radiation branch 12 and the first ground point G1 coincides with the third ground point G3, the second radiation branch 12 and the feeding excitation branch 13 are an integral metal segment provided at the frame 10 of the electronic device 100, and the first radiation branch 11 is another independent metal segment provided at the frame 10 of the electronic device 100 which is spaced, by a gap, from the metal segment forming the second radiation branch 12 and the feeding excitation branch 13.

When the frame 10 of the electronic device 100 may also be a non-metal frame, the first radiation branch 11, the second radiation branch 12 and the feeding excitation branch 13 may be embedded in the frame 10 of the electronic device 100, or provided on the inner side of the frame 10 of the electronic device 100.

In some embodiments, as illustrated in FIG. 8, the first side B1 is a short side of the electronic device 100, and the second side B2 is a long side of the electronic device 100. Thus, since the adjacent first side B1 and second side B2 are perpendicular to each other, the first radiation branch 11 and the second radiation branch 12 are also perpendicular to each other, that is, they are in vertical orthogonality, thereby achieving better vertical orthogonal polarization.

Evidently, in some other embodiments, the first side B1 may be a long side of the electronic device 100, and the second side B2 may be a short side of the electronic device 100.

As illustrated in FIG. 8, the frame 10 is arc-shaped at the top corner between the first side B1 and the second side B2, and the feeding excitation branch 13 is an arc-shaped segment.

As illustrated in FIG. 8, in some embodiments, the first side B1 is a short side at the top of the electronic device 100, and the second side B2 is a long side at the left side of the electronic device 100.

The directional terms such as “top” and “bottom” used in the embodiments of the present disclosure to describe the electronic device 100 are mainly explained based on the orientation when the user holds the electronic device 100 in hand. The position at the top side of the electronic device 100 is referred to as the “top”, and the position at the bottom side of the electronic device 100 is referred to as the “bottom”. It does not indicate or imply that the device or element referred to must have a specific orientation, or be constructed and operated in a specific orientation. Therefore, they cannot be understood as a limitation on the orientation of the electronic device 100 in actual application scenarios. In some embodiments, the bottom end of the electronic device 100 is an end where a headphone jack and an USB port are provided, and the top end of the electronic device 100 is another end opposite to the end where the headphone jack and the USB port are provided, and may also refer to an end where a camera, a receiver, etc. are provided.

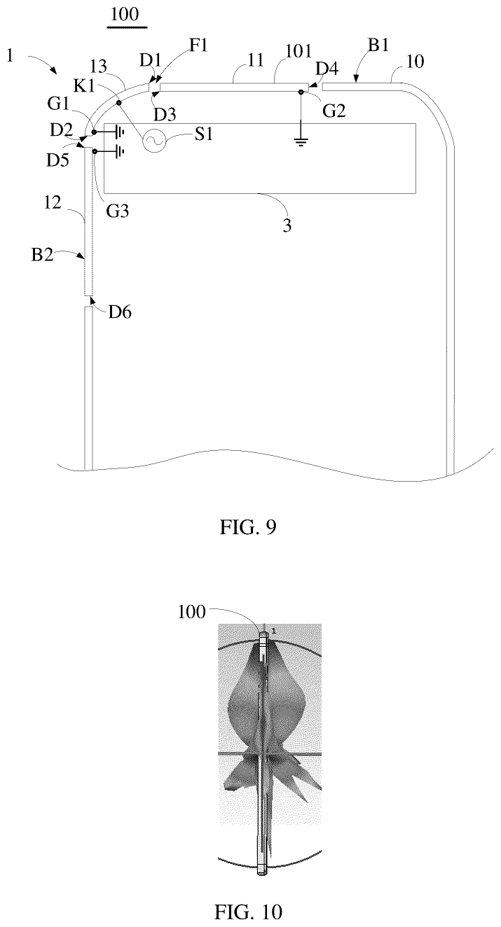

As shown in FIG. 8, the electronic device 100 further includes a display screen 2, and the schematic diagram shown in FIG. 9 is a schematic diagram viewed from one side of the display screen 2. The “left” and “right” are those viewed from the perspective of FIG. 9.

Evidently, in some embodiments, the first side B1 is also a short side at the top of the electronic device 100, and the second side B2 is a long side on the right side of the electronic device 100, and so on.

Referring to FIG. 9, a partial structural schematic diagram of the electronic device 100 including the aforementioned antenna assembly 1 in some embodiments of the present disclosure is shown. As illustrated in FIG. 9, the electronic device 100 further includes a circuit board 3, and the feed source S1 may be provided on the circuit board 3. The feeding point K1 is connected with the feed source S1. As illustrated in FIG. 9, the first ground point G1, the second ground point G2 and the third ground point G3 are connected to the ground on the circuit board 3. Specifically, FIG. 9 illustrates an example in which the electronic device 100 includes the antenna assembly 1 shown in FIG. 4.

The circuit board 3 may be a main board. The ground on the circuit board 3 may be ground of the main board, such as a ground region or a ground layer on the circuit board 3. In some embodiments, the middle frame of the electronic device 100 is the ground of the entire device, and the ground of the main board may be connected to the middle frame of the electronic device 100 (not shown in the figure), so that the first ground point G1, the second ground point G2 and the third ground point G3 are connected to the middle frame of the electronic device 100, so as to be connected to the ground of the entire device. The aforementioned ground may be the ground on the circuit board 3 or the ground of the middle frame.

The specific structure of the antenna assembly 1 shown in FIG. 9 does not include the first tuner 14, the second tuner 15 and the third tuner 16. Evidently, when the antenna assembly 1 includes the first tuner 14, the second tuner 15 and the third tuner 16, the first ground point G1 is connected to the ground on the circuit board 3 through the first tuner 14, the second ground point G2 is connected to the ground on the circuit board 3 through the second tuner 15, and the third ground point G3 is connected to the ground on the circuit board 3 through the third tuner 16.

In some embodiments, the first radiation branch 11, the second radiation branch 12 and the feeding excitation branch 13 may also be metal segments provided on the circuit board 3. For example, the first radiation branch 11, the second radiation branch 12 and the feeding excitation branch 13 are flexible printed circuit (FPC) metal segments fixedly provided on an antenna bracket(s) or laser-direct-structuring (LDS) metal segments formed on an antenna bracket(s) by laser technology, and then they are arranged on the circuit board 3 through the antenna bracket(s).

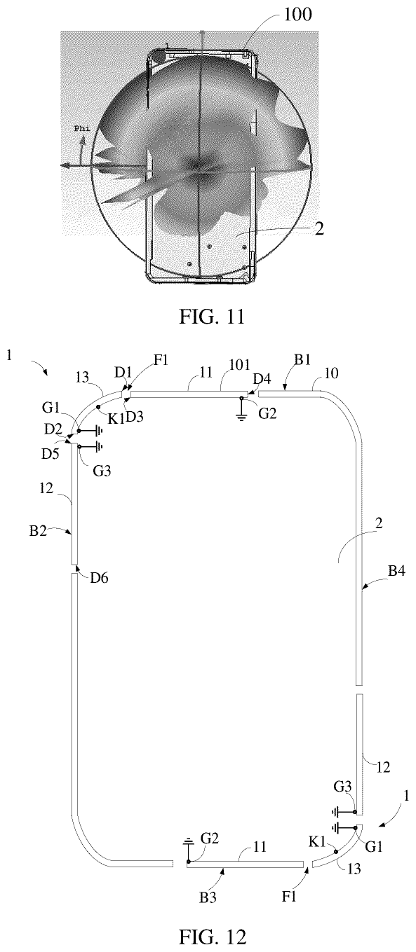

Referring to FIG. 10, a schematic diagram of a first three-dimensional axial ratio simulation of the electronic device 100 in some embodiments of the present disclosure is shown. The first three-dimensional axial ratio simulation diagram of the electronic device 100 shown in FIG. 11 is a three-dimensional axial ratio simulation diagram of side radiation obtained by simulation based on the electronic device 100 including the structure of the antenna assembly 1 shown in any of the aforementioned embodiments.

As can be seen from FIG. 10, when viewed from the side of the electronic device 100, the intensities of radiation radiated by the antenna assembly 1 sideward substantially are approximately equal within a circle centered on the top, so that the ratio of the maximum radiation intensity to the minimum radiation intensity is approximately 1, which achieves a low axial ratio in the lateral direction of the electronic device 100.

The lower the axial ratio, the better the circular polarization characteristics. The lowest axial ratio is generally 1.

FIG. 10 is specifically a schematic diagram of three-dimensional axial ratio simulation viewed from the long side where the second radiation branch 12 is provided.

Referring to FIG. 11, a schematic diagram of a second three-dimensional axial ratio simulation of the electronic device 100 in some embodiments of the present disclosure is shown. The second three-dimensional axial ratio simulation schematic diagram of the electronic device 100 shown in FIG. 11 is a three-dimensional axial ratio simulation schematic diagram of planar radiation obtained by simulation based on the electronic device 100 including the antenna assembly 1 shown in any of the aforementioned embodiments.

As can be seen from FIG. 11, when viewed from a plane where the display screen 2 of the electronic device 100 is located, the intensities of radiation radiated by the antenna assembly 1 in most directions within the plane of the display screen 2 are substantially equal, which appears to be circular. Thus, the ratio of the maximum radiation intensity to the minimum radiation intensity is approximately 1, and a low axial ratio is also achieved in the plane where the display screen 2 of the electronic device 100 is located. Therefore, the electronic device 100 achieves good vertical orthogonal polarization.

The electronic device 100 includes at least one antenna assembly 1. That is, the electronic device 100 may include one or more antenna assemblies 1.

Referring to FIG. 12, another schematic plan view of the electronic device 100 in some embodiments of the present disclosure is shown. As shown in FIG. 12, the electronic device 100 may include two antenna assemblies 1, and each antenna assembly 1 includes the aforementioned structure.

As illustrated in FIG. 12, one antenna assembly 1 is provided at the upper left corner of the electronic device 100, and the other antenna assembly 1 is provided at the lower right corner of the electronic device 100. The “upper left” and “lower right” are all directions from the viewing angle shown in FIG. 12.

As illustrated in FIG. 12, the first radiation branch 11 of the antenna assembly 1 located at the upper left corner of the electronic device 100 is a metal segment provided at a part of the frame 10 on the first side B1 of the electronic device 100, and the second radiation branch 12 of this antenna assembly is a metal segment provided at a part of the frame 10 on the second side B2 of the electronic device 100, the first side B1 and the second side B2 being adjacent to each other. The feeding excitation branch 13 of this antenna assembly is a metal segment provided on a part of the frame 10 at the top corner between the first side B1 and the second side B2 of the electronic device 100.

The first radiation branch 11 of the antenna assembly 1 located at the lower right corner of the electronic device 100 is a metal segment provided at a part of the frame 10 on the third side B3 of the electronic device 100, and the second radiation branch 12 of this antenna assembly is a metal segment provided at a part of the frame 10 on the fourth side B4 of the electronic device 100, the third side B3 and the fourth side B4 being adjacent to each other. The feeding excitation branch 13 of this antenna assembly is a metal segment provided on a part of the frame 10 at the top corner between the third side B3 and the fourth side B4 of the electronic device 100.

As illustrated in FIG. 12, in some embodiments, the first side B1 is a short side located at the top of the electronic device 100, the third side B3 is a short side at the bottom of the electronic device 100, the second side B2 is a long side on the left side of the electronic device 100, and the fourth side B4 is a long side on the right side of the electronic device 100.

In some embodiments, one of the two antenna assemblies 1 may support transmission of satellite communication signals and the other one may support reception of the same satellite communication signals. For example, the electrical length of each the feeding excitation branch 13, the first radiation branch 11 and the second radiation branch 12 of one antenna assembly is λ₂/4, where 21 is the transmit frequency of the satellite communication signal; and the electrical length of each of the feeding excitation branch 13, the first radiation branch 11 and the second radiation branch 12 of another antenna assembly is λ₂/4, where 22 is the receive frequency of the satellite communication signal. In this way, the two antenna assemblies may resonate at the transmit frequency and the receive frequency of the satellite communication signals respectively, and support the transmission and reception of the satellite communication signals respectively. In some embodiments, satellite communication signals supported by the two antenna assemblies 1 are the same, for example, both are Beidou satellite communication signals, in which one of the antenna assemblies may support the transmission of the satellite communication signal, and the other of the antenna assemblies may support the reception of the same satellite communication signal. Thus, in some embodiments, when the electronic device 100 includes two antenna assemblies 1 at the same time, one of the antenna assemblies may be used as a transmitting antenna and the other of the antenna assemblies may be used as a receiving antenna, so that dual-frequency circular polarization or dual-frequency elliptical polarization can be realized under the same satellite communication system, thereby realizing the transmission and reception of satellite communication signals at the same time.

In some embodiments, each of the two antenna assemblies 1 may further include the aforementioned first tuner 14, second tuner 15 and third tuner 16. Each of the two antenna assemblies can support the transmission and reception of satellite communication signals, and each of the two antenna assemblies can support the transmission and reception of different satellite communication signals. For example, one antenna assembly 1 may support the transmission and reception of a first satellite communication signal, and the other antenna assembly 1 may support the transmission and reception of a second satellite communication signal. Thus, one antenna assembly 1 independently supports the transmission and reception of the first satellite communication signal, and the other antenna assembly 1 independently supports the transmission and reception of the second satellite communication signal, which enables dual-frequency circular polarization or dual-frequency elliptical polarization under different satellite communication systems. Therefore, at a same time, the antenna assemblies 1 can simultaneously transmit or receive the first satellite communication signal and transmit or receive the second satellite communication signal, thereby effectively improving the performance and reliability of satellite communication. The first satellite communication signal may be a Beidou satellite communication signal, and the second satellite communication signal may be a satellite communication signal of other satellite communication systems.

Evidently, in some other embodiments, the electronic device 100 may further include three antenna assemblies 1, or even four antenna assemblies 1. For example, at each of the upper left corner, the upper right corner, the lower left corner, and the lower right corner of the electronic device 100, one antenna assembly 1 may be provided.

When the frame 10 of the electronic device 100 is a metal frame, the first radiation branch 11, the second radiation branch 12 and the feeding excitation branch 13 of each antenna assembly 1 are metal frame segments formed by providing gaps F1 in the metal frame of the electronic device 100.

When the frame 10 of the electronic device 100 is a non-metal frame, the first radiation branch 11, the second radiation branch 12 and the feeding excitation branch 13 of each antenna assembly 1 are metal segments provided at the frame 10 of the electronic device 100, for example, they are metal segments embedded in the frame 10 of the electronic device 100 or metal segments provided on the inner side of the frame 10 of the electronic device 100.

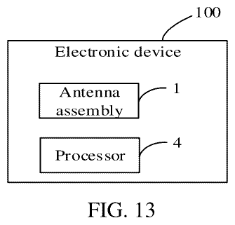

Referring to FIG. 13, a further structural block diagram of the electronic device 100 in some embodiments of the present disclosure is shown. As illustrated in FIG. 13, the electronic device 100 includes the antenna assembly 1 and a processor 4. When the antenna assembly 1 further includes the first tuner 14, the second tuner 15 and the third tuner 16, the processor 4 is connected to the first tuner 14, the second tuner 15 and the third tuner 16, and is also used to control the first tuner 14, the second tuner 15 and the third tuner 16 to be enabled or disabled.

For example, in some embodiments, the original electrical length of each of the feeding excitation branch 13, the first radiation branch 11 and the second radiation branch 12 is λ₂/4, where A1 is the wavelength corresponding to the transmit frequency of a satellite communication signal. That is, in some embodiments, the electrical lengths of the feeding excitation branch 13, the first radiation branch 11, and the second radiation branch 12 are mainly designed based on the transmission of the satellite communication signal. Therefore, at the time of transmitting the satellite communication signal, the electrical lengths of the feeding excitation branch 13, the first radiation branch 11 and the second radiation branch 12 have met the requirements. In this case, the processor 4 controls the first tuner 14, the second tuner 15 and the third tuner 16 to be disabled. At the time of receiving a satellite communication signal, the processor 4 controls the first tuner 14, the second tuner 15 and the third tuner 16 to be enabled, so that the electrical length of each of the feeding excitation branch 13, the first radiation branch 11 and the second radiation branch 12 is adjusted to λ₂/4, where 22 is the wavelength corresponding to the receive frequency of the satellite communication signal, thereby supporting the reception of the satellite communication signal.

As mentioned above, each of the first tuner 14, the second tuner 15 and the third tuner 16 includes a tuning element X1 and a tuning switch W1 connected in parallel between the corresponding ground point and the ground. In some embodiments, the processor 4 is specifically configured to, at the time of transmitting a satellite communication signal, control the tuning switch W 1 in each of the first tuner 14, the second tuner 15 and the third tuner 16 to be turned on, so as to make the branch where the corresponding tuning element X1 is located be short-circuited. Thus, the first tuner 14, the second tuner 15 and the third tuner 16 are disabled at the time of transmitting the satellite communication signal. The processor 4 is further configured to, at the time of receiving a satellite communication signal, control the tuning switch W1 in each of the first tuner 14, the second tuner 15 and the third tuner 16 to be turned off, so as to make the branch where the corresponding tuning element X1 is located be switched in. Thus, the first tuner 14, the second tuner 15 and the third tuner 16 are enabled at the time of receiving the satellite communication signal.

In some other embodiments, the original electrical lengths of each of the feeding excitation branch 13, the first radiation branch 11 and the second radiation branch 12 is λ₂/4, where 12 is the wavelength corresponding to the receive frequency of a satellite communication signal. That is, in some other embodiments, the electrical lengths of the feeding excitation branch 13, the first radiation branch 11 and the second radiation branch 12 are mainly designed based on the reception of the satellite communication signal. Therefore, at the time of receiving the satellite communication signal, the electrical lengths of the feeding excitation branch 13, the first radiation branch 11 and the second radiation branch 12 have met the requirements. In this case, the processor 4 controls the first tuner 14, the second tuner 15 and the third tuner 16 to be disabled. At the time of transmitting a satellite communication signal, the processor 4 controls the first tuner 14, the second tuner 15 and the third tuner 16 to be enabled, so that the electrical length of each of the feeding excitation branch 13, the first radiation branch 11 and the second radiation branch 12 is adjusted λ₂/4, where A1 is the wavelength corresponding to the transmit frequency of the satellite communication signal, thereby supporting the transmission of the satellite communication signal.

Similarly, each of the first tuner 14, the second tuner 15 and the third tuner 16 includes a tuning element X1 and a tuning switch W1 connected in parallel between the corresponding ground point and the ground. In some embodiments, the processor 4 is specifically configured to, at the time of receiving a satellite communication signal, control the tuning switch W1 in each of the first tuner 14, the second tuner 15 and the third tuner 16 to be turned on, so as to make the branch where the corresponding tuning element X1 is located be short circuited. Thus, the first tuner 14, the second tuner 15 and the third tuner 16 are disabled at the time of receiving the satellite communication signal. The processor 4 is further configured to, at the time of transmitting a satellite communication signal, control the tuning switch W1 in each of the first tuner 14, the second tuner 15 and the third tuner 16 to be turned off, so as to make the branch where the corresponding tuning element X1 is located be switched in. Thus, the first tuner 14, the second tuner 15 and the third tuner 16 are enabled at the time of transmitting the satellite communication signal.

The tuning switch W1 may be a transistor such as a MOS tube or a triode. The processor 4 controls the tuning switch W1 to be turned on or off by outputting a corresponding level signal. For example, when the tuning switch W1 is a MOS tube, the processor 4 is connected to the gates of all NM OS tubes of the first tuner 14, the second tuner 15 and the third tuner 16, and outputs a corresponding high-level or low-level signal as needed to control the tuning switches W1 to be turned on or off, or turned off or on.

The processor 4 may be a central processing unit, a microcontroller, a single chip microcomputer, a digital signal processor, etc.

The electronic device 100 of the present disclosure may be any electronic device with an antenna, such as a mobile phone or a tablet computer. The electronic device 100 may further include other elements, which are irrelevant to the improvement of the present disclosure and will not be described in detail here.

In the antenna assembly 1 and the electronic device 100 of the present disclosure, the feeding excitation branch 13 of the antenna assembly 1 is electrically coupled with the first radiation branch 11 and magnetically coupled with the second radiation branch 12, so that the phase difference between two coupled feeding signals obtained respectively through the electrical coupling and magnetic coupling of the feeding signal received by the feeding excitation branch 13 is 90°. In addition, the first radiation branch 11 and the second radiation branch 12 are at an angle relative to each other. As such, the first radiation branch 11 and the second radiation branch 12 have circular polarization radiation characteristics or elliptical polarization radiation characteristics. Accordingly, the reception and/or transmission of satellite communication signals is enabled through a simple and compact structure. The electronic device 100 may be equipped with such simple and compact antenna assembly to transmit and/or receive satellite communication signals, which enables the electronic device to have a small overall size and be easy to carry.

The foregoing only describes specific implementations of the present disclosure, but the scope of protection of the present disclosure is not limited thereto. Any technician familiar with the technical field can easily think of changes or substitutions within the technical scope disclosed in the present disclosure, and such changes and substitutions should fall within the scope of protection of the present disclosure. The embodiments of the present disclosure and the features in the embodiments can be combined with each other without conflict. Therefore, the scope of protection of the present disclosure shall be subjected to those of the claims.

What is claimed is:

1. An antenna assembly, comprising:
a first radiation branch;
a second radiation branch, wherein the first radiation branch and the second radiation branch are at an angle relative to each other; and
a feeding excitation branch, wherein the feeding excitation branch is located between the first radiation branch and the second radiation branch, and the feeding excitation branch comprises a feeding point configured to receive a feeding signal;
the feeding excitation branch is configured to be electrically coupled with the first radiation branch, to couple the feeding signal to the first radiation branch and provide a first coupled feeding signal fed into the first radiation branch, the feeding excitation branch is further configured to be magnetically coupled with the second radiation branch, to couple the feeding signal to the second radiation branch and provide a second coupled feeding signal fed into the second radiation branch, a phase difference between the first coupled feeding signal and the second coupled feeding signal being 90°, so that the first radiation branch and the second radiation branch have circular polarization radiation characteristics or elliptical polarization radiation characteristics, and the antenna assembly is enabled to support reception and/or transmission of a satellite communication signal.

2. The antenna assembly as claimed in claim 1, wherein the feeding excitation branch further comprises a first end, a second end and a first ground point, the first ground point is configured for grounding and provided at the second end, the first end is an open-circuit end, and the feeding point is provided between the first ground point and the first end;
the first radiation branch comprises a third end, a fourth end and a second ground point, the second ground point is configured for grounding and provided at the fourth end, and the third end is an open-circuit end;
the second radiation branch comprises a fifth end, a sixth end and a third ground point, the third ground point is configured for grounding and provided at the fifth end, and the sixth end is an open-circuit end;
the first end of the feeding excitation branch is directly opposite to and spaced apart from the third end of the first radiation branch; and
the second end of the feeding excitation branch is directly opposite to and spaced apart from the fifth end of the second radiation branch, or the second end of the feeding excitation branch is connected to the fifth end of the second radiation branch and the first ground point coincides with the third ground point.

3. The antenna assembly as claimed in claim 2, wherein the antenna assembly further comprises a feed source, the feed source is configured to generate the feeding signal, the feeding excitation branch is configured to couple, through the electrical coupling, the feeding signal generated by the feed source to the first radiation branch to provide the first coupled feeding signal fed into the first radiation branch, and the feeding excitation branch is further configured to couple, through the magnetic coupling, the feeding signal generated by the feed source to the second radiation branch to provide the second coupled feeding signal fed into the second radiation branch, and the first radiation branch and the second radiation branch are configured to transmit the satellite communication signal under excitation of the first coupled feeding signal and the second coupled feeding signal respectively.

4. The antenna assembly as claimed in claim 3, wherein an electrical length of each of the feeding excitation branch, the first radiation branch, and the second radiation branch is λ₂/4, where λ₁ is a wavelength corresponding to a transmit frequency of the satellite communication signal.

5. The antenna assembly as claimed in claim 3, wherein the antenna assembly further comprises a first tuner, a second tuner and a third tuner, the first tuner is connected between the first ground point and ground, the second tuner is connected between the second ground point and the ground, and the third tuner is connected between the third ground point and the ground; and
at a time of receiving the satellite communication signal, each of the first tuner, the second tuner and the third tuner is configured to be enabled to adjust an electrical length of each of the feeding excitation branch, the first radiation branch and the second radiation branch to λ₂/4 for the reception of the satellite communication signal, where 22 is a wavelength corresponding to a receive frequency of the satellite communication signal.

6. The antenna assembly as claimed in claim 5, wherein each of the first tuner, the second tuner and the third tuner comprises a tuning element and a tuning switch connected in parallel between a corresponding ground point and the ground, and the tuning switch of each of the first tuner, the second tuner and the third tuner is configured to be turned off at the time of receiving the satellite communication signal to enable a corresponding tuning element, so that the first tuner, the second tuner and the third tuner are configured to be enabled at the time of receiving the satellite communication signal.

7. The antenna assembly as claimed in claim 2, wherein the feeding signal is a received satellite communication signal, the feeding excitation branch is configured to couple, through the electrical coupling, the received satellite communication signal to the first radiation branch to provide the first coupled feeding signal fed into the first radiation branch, and the feeding excitation branch is further configured to couple, through the magnetic coupling, the received satellite communication signal to the second radiation branch to provide the second coupled feeding signal fed into the second radiation branch, and the first radiation branch and the second radiation branch are configured to receive the satellite communication signal under excitation of the first coupled feeding signal and the second coupled feeding signal respectively.

8. The antenna assembly as claimed in claim 7, wherein an electrical length of each of the feeding excitation branch, the first radiation branch, and the second radiation branch is λ₂/4, where λ₂ is a wavelength corresponding to a receive frequency of the satellite communication signal.

9. The antenna assembly as claimed in claim 7, wherein the antenna assembly further comprises a first tuner, a second tuner and a third tuner, the first tuner is connected between the first ground point and ground, the second tuner is connected between the second ground point and the ground, and the third tuner is connected between the third ground point and the ground; and
at a time of transmitting the satellite communication signal, each of the first tuner, the second tuner and the third tuner is configured to be enabled to adjust an electrical length of each of the feeding excitation branch, the first radiation branch and the second radiation branch to λ₂/4 for the transmission of the satellite communication signal, where λ₁ is a wavelength corresponding to a transmit frequency of the satellite communication signal.

10. The antenna assembly as claimed in claim 9, wherein each of the first tuner, the second tuner and the third tuner comprises a tuning element and a tuning switch connected in parallel between a corresponding ground point and the ground, and the tuning switch of each of the first tuner, the second tuner and the third tuner is configured to be turned off at the time of transmitting the satellite communication signal to enable a respective tuning element, so that the first tuner, the second tuner and the third tuner are configured to be enabled at the time of transmitting the satellite communication signal.

11. The antenna assembly as claimed in claim 1, wherein the angle between the first radiation branch and the second radiation branch is greater than 0° and less than 180°.

12. The antenna assembly as claimed in claim 11, wherein the angle between the first radiation branch and the second radiation branch is 90°.

13. The antenna assembly as claimed in claim 2, wherein a receive frequency and a transmit frequency of the satellite communication signal are the same, and the first ground point, the second ground point and the third ground point are directly grounded.

14. An electronic device, comprising an antenna assembly comprising:
a first radiation branch;
a second radiation branch at an angle relative to the first radiation branch; and
a feeding excitation branch, wherein the feeding excitation branch is located between the first radiation branch and the second radiation branch, and the feeding excitation branch comprises a feeding point configured to receive a feeding signal;
the feeding excitation branch is configured to be electrically coupled with the first radiation branch, to couple the feeding signal to the first radiation branch and provide a first coupled feeding signal fed into the first radiation branch, the feeding excitation branch is further configured to be magnetically coupled with the second radiation branch, to couple the feeding signal to the second radiation branch and provide a second coupled feeding signal fed into the second radiation branch, a phase difference between the first coupled feeding signal and the second coupled feeding signal being 90°, so that the first radiation branch and the second radiation branch have circular polarization radiation characteristics or elliptical polarization radiation characteristics, and the antenna assembly is enabled to support reception and/or transmission of a satellite communication signal.

15. The electronic device as claimed in claim 14, wherein a frame of the electronic device is a metal frame, and the first radiation branch, the second radiation branch, and the feeding excitation branch are metal frame segments formed by providing gaps in the metal frame of the electronic device.

16. The electronic device as claimed in claim 15, wherein the first radiation branch is formed by a part of the metal frame on a first side of the electronic device, and the second radiation branch is formed by a part of the metal frame on a second side of the electronic device, the first side and the second side being adjacent to each other; and the feeding excitation branch is a metal frame segment at a top corner between the first side and the second side.

17. The electronic device as claimed in claim 14, wherein a frame of the electronic device is a non-metal frame, and the first radiation branch, the second radiation branch and the feeding excitation branch are metal segments provided at the frame of the electronic device.

18. The electronic device as claimed in claim 17, wherein the first radiation branch is a metal segment provided at a part of the frame on a first side of the electronic device, and the second radiation branch is a metal segment provided at a part of the frame on a second side of the electronic device, the first side and the second side being adjacent to each other; and the feeding excitation branch is a metal segment provided at a top corner between the first side and the second side of the electronic device.

19. The electronic device as claimed in claim 14, wherein the electronic device further comprises a circuit board, and each of the first radiation branch, the second radiation branch and the feeding excitation branch is provided on the circuit board through an antenna bracket.

20. The electronic device as claimed in claim 14, wherein at least one antenna assembly is comprised in the electronic device.
